(19) United States
(12) Patent Application Publication
(10) Pub. No.: US 2018/0209460 A1
(43) Pub. Date: Jul. 26, 2018

(54) MULTI-WAY PIPE CONNECTOR FOR TUBULAR FRAME

(71) Applicant: Ching-Chi LIN, New Taipei City (TW)

(72) Inventor: Ching-Chi LIN, New Taipei City (TW)

(21) Appl. No.: 15/429,996

(22) Filed: Feb. 10, 2017

(30) Foreign Application Priority Data
Jan. 26, 2017 (TW) 106201532

(51) Int. Cl. F16B 12/40; F16B 12/44

(52) U.S. Cl. CPC F16B 12/40; F16B 2012/446; F16B 12/44

(57) ABSTRACT

A multi-way pipe connector for a tubular frame, applied to connect a plurality of connection tubes so as to form the tubular frame, includes a main connector body, a plurality of connection protrusions and a plurality of elastic O-rings. The connection protrusions are extending individually in corresponding extension directions from the main connector body, and each of the connection protrusions has an outer wall including at least one annular groove. Each of the plurality of elastic O-rings is to sleeve one said corresponding annular groove of the respective connection protrusion so as to form a dimensional interference fit relationship with an inner wall of the corresponding connection tube sleeving the connection protrusion.

This application claims the benefit of Taiwan Patent Application Serial No. 106201532, filed Jan. 26, 2017, the subject matter of which is incorporated herein by reference.

### BACKGROUND OF THE INVENTION

### 1. Field of the Invention

The invention relates to a multi-way pipe connector for a tubular frame, and more particularly to the multi-way pipe connector that introduces an elastic O-ring into an annular groove of a connection protrusion so as to establish an interference fit between with a connection tube of the tubular frame.

### 2. Description of the Prior Art

Generally speaking, while in assembling a tubular frame for building a cabinet or a structure the like, plenty of connectors are required to connect tubes or pipes for producing the tubular frame. In particular, while a conventional connector is applied to connect a number of the connection tubes, specific tools, such as screws or the like, are usually necessary for completing the connection and the fixation of the desired tubular frame. However, it is obvious that such kind of assembling the tubular frame is labor costing. Hence, an improvement thereupon for facilitating the assembly of the tubular frame is definitely welcome to the skill in the art.

### SUMMARY OF THE INVENTION

In view that application of the conventional connection connectors involves additional tools for ensuring the connection with the connection tubes and inevitably leads to problems in lousy assembling and time consumption, accordingly, it is an object of the present invention to provide a multi-way pipe connector for a tubular frame that introduces an elastic O-ring to form interference with the connection tube, such that labor time needed for assembling of the tubular frame can be substantially reduced.

In the present invention, the multi-way pipe connector for a tubular frame, applied to connect a plurality of connection tubes so as to form the tubular frame, includes a main connector body, a plurality of connection protrusions and a plurality of elastic O-rings. The plurality of connection protrusions are extending individually in corresponding extension directions from the main connector body, and each of the plurality of connection protrusions has an outer wall including at least one annular groove. Each of the plurality of elastic O-rings is to sleeve one said corresponding annular groove of the respective connection protrusion so as to form a dimensional interference fit relationship with an inner wall of the corresponding connection tube sleeving the connection protrusion.

In one embodiment of the present invention, each of the plurality of elastic O-rings is an annular elastic O-ring, and at least one of the plurality of connection protrusions is shaped to be a column having a circular cross section. At least two of the plurality of extension directions are perpendicular to each other. In particular, the multi-way pipe connector is a three-way orthogonal connection assembly having the plurality of extension directions perpendicular to each other, each of the plurality of connection protrusions is a solid columns, and the main connector body is a spherical body having a diameter greater than an outer diameter of the connection protrusion.

In one embodiment of the present invention, the multi-way pipe connector is a T-shape three-way connection assembly having one of the plurality of extension directions to be perpendicular to other two of the plurality of extension directions.

In one embodiment of the present invention, the multi-way pipe connector is a four-way connection assembly.

By providing the multi-way pipe connector for a tubular frame of the present invention, since the elastic O-ring can form an interference fit with the connection tube so that a tight engagement between the pipe connector and the corresponding connection tube can be simply ensured by sending the connection tube to sleeve into the corresponding connection protrusion, thus no auxiliary tool is needed anymore for assembling the tubular frame. Thereupon, assembly time of the tubular frame can be reduced, and assembly efficiency thereof can be substantially enhanced as well.

All these objects are achieved by the multi-way pipe connector for a tubular frame described below.

### BRIEF DESCRIPTION OF THE DRAWINGS

The present invention will now be specified with reference to its preferred embodiments illustrated in the drawings, in which:

FIG. 1 is a schematic perspective view of a first embodiment of the multi-way pipe connector for a tubular frame in accordance with the present invention;

FIG. 2 is a lateral side view of FIG. 1;

FIG. 3 is a schematic perspective view of a second embodiment of the multi-way pipe connector for a tubular frame in accordance with the present invention; and

FIG. 4 is a schematic perspective view of a fourth embodiment of the multi-way pipe connector for a tubular frame in accordance with the present invention.

### DESCRIPTION OF THE PREFERRED EMBODIMENT

The invention disclosed herein is directed to a multi-way pipe connector for a tubular frame. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

Though various examples for the multi-way pipe connector for a tubular frame can be directly derived in accordance with the present invention, yet, for a concise explanation toward the present invention, only three embodiments of these examples are raised in the following description.

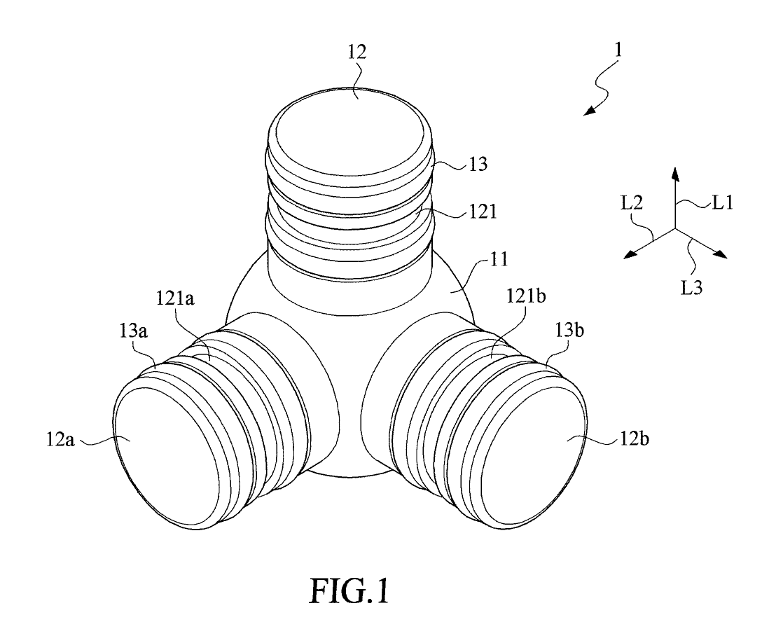

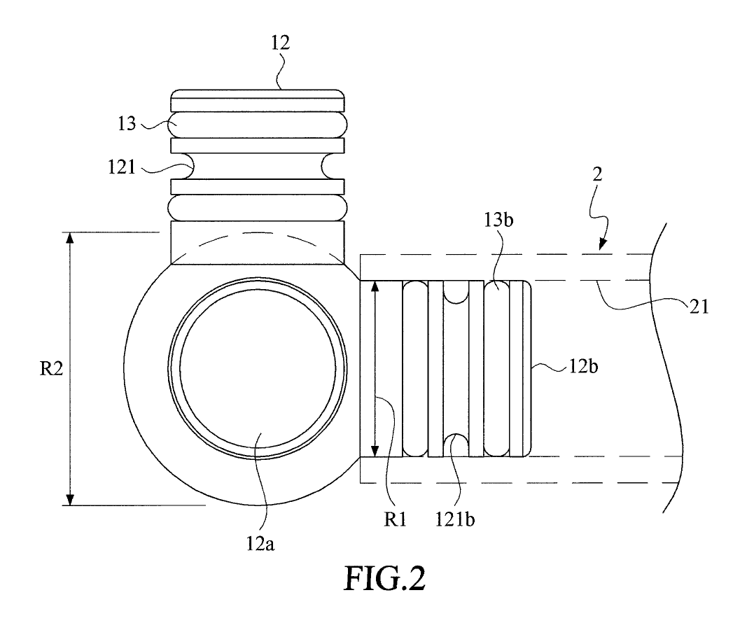

Refer now to FIG. 1 and FIG. 2; where FIG. 1 is a schematic perspective view of a first embodiment of the multi-way pipe connector for a tubular frame in accordance with the present invention, and FIG. 2 is a lateral side view of FIG. 1.

As shown, this first embodiment of the multi-way pipe connector for a tubular frame 1 (the multi-way pipe connector 1 thereafter) is a three-way orthogonal connection assembly for connecting a plurality of connection tubes 2, so as to construct a tubular frame (not shown in the figures). Namely, the tubular frame is consisted of a plurality of the multi-way pipe connectors 1 and a plurality of the connection tubes 2.

The multi-way pipe connector 1 includes a main connector body 11, a plurality of connection protrusions 12, 12a and 12b and a plurality of elastic O-rings 13, 13a and 13b (one labeled in each of the figures). The main connector body 11 is formed as, but not limited to, a spherical body.

The plurality of connection protrusions 12, 12a and 12b are individually protruded from the main connector body 11 toward a plurality of extension directions L1, L2 and L3, respectively. Each of the connection protrusions 12, 12a and 12b is formed as a solid column. In particular, at least one of the connection protrusions 12, 12a and 12b is shaped to have a circular cross section. However, in some other embodiments, the connection protrusion can be formed to have a specific shape of cross section such as a polygon, an oval shape or other shape the like.

In addition, each of the connection protrusions 12, 12a and 12b has an outer wall furnished with at least one annular groove (121, 121a and 121b for the three connection protrusions 12, 12a and 12b, respectively, and the number being made only to the annular groove without an elastic O-ring). In this embodiment, at least two of the extension directions L1, L2 and L3 are established othogonally. For example, in this first embodiment, the plurality of extension directions L1, L2 and L3 are all othogonally; i.e., perpendicular to each other. Further, the outer diameter R1 of each of the connection protrusions 12, 12a and 12b is smaller than the diameter R2 of the spherical body so as to ensure connections between the connection protrusion 12, 12a or 12b and the main connector body 11 and thus to avoid accidental breaking down.

Each of the plurality of elastic O-rings 13, 13a and 13b is to sleeve one corresponding annular groove 121, 121a or 121b of the connection protrusion 12, 12a or 12b, respectively. In the present invention, each of the elastic O-rings 13, 13a and 13b is formed into a dimensional interference fit relationship with the corresponding inner wall 21 of the respective connection tube 2. Such a dimensional interference fit relationship is made according to specific specification or standard so as to form a firm and tight engagement between the connection tube 2 and the corresponding connection protrusion 12, 12a or 12b.

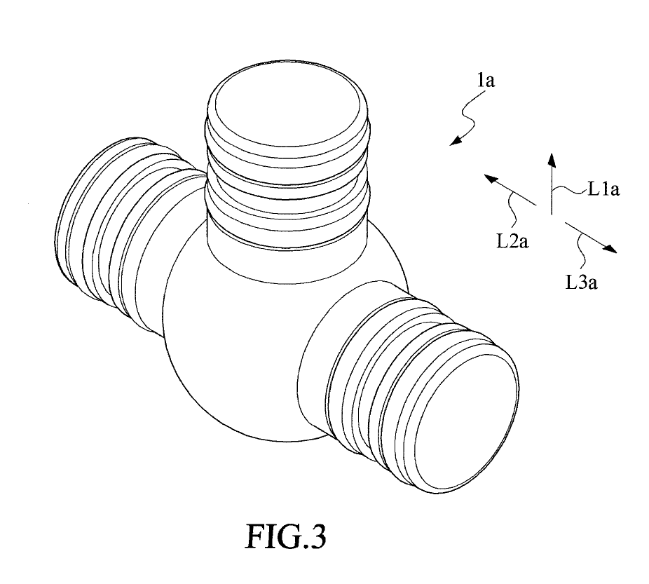

Referring now to FIG. 3, a schematic perspective view of a second embodiment of the multi-way pipe connector for a tubular frame in accordance with the present invention is demonstrated. As shown, the major different between the second embodiment and the previous first embodiment is that the multi-way pipe connector for a tubular frame 1a of this second embodiment is a T-shape three-way connection assembly who has one out of the three extension directions L1a, L2a and L3a to be perpendicular to the other two thereof. As shown, in this second embodiment, the extension direction L1a is perpendicular to the extension directions L2a and L3a. Except that, the first embodiment and the second embodiment are structurally the same, and thus details thereabout are omitted herein.

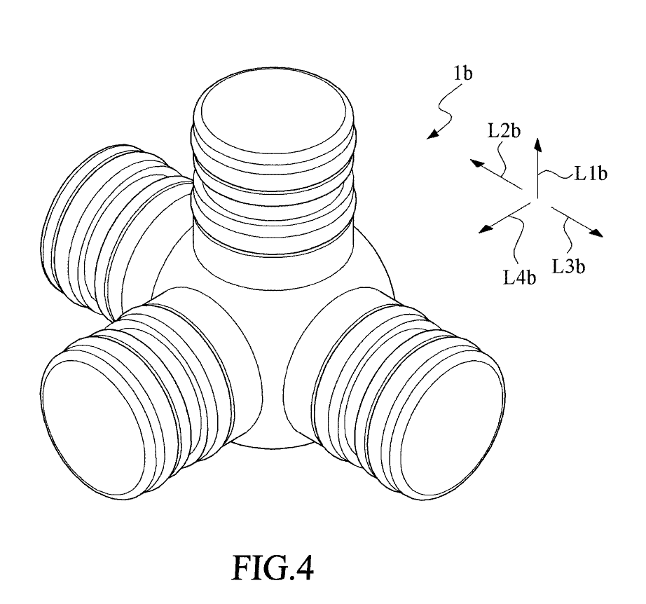

Referring now to FIG. 4, a schematic perspective view of a third embodiment of the multi-way pipe connector for a tubular frame in accordance with the present invention is demonstrated. As shown, the major different between the third embodiment and the previous first embodiment is that the multi-way pipe connector for a tubular frame 1b of this third embodiment is a four-way connection assembly, i.e. an assembly having the extension direction L1b to be perpendicular to the other three extension directions L2b, L3b and L4b (but note the extension directions L2b and L3b are going to reverse directions). Except that, the first embodiment and the third embodiment are structurally the same, and thus details thereabout are omitted herein.

In summary, by providing the multi-way pipe connector for a tubular frame of the present invention, since the elastic O-ring can form an interference fit with the connection tube so that a tight engagement between the pipe connector and the corresponding connection tube can be simply formed by sending the connection tube to sleeve into the corresponding connection protrusion, thus no auxiliary tool is needed anymore for assembling the tubular frame. Thereupon, the assembly time of the tubular frame can be reduced, and the assembly efficiency thereof can be substantially enhanced as well.

While the present invention has been particularly shown and described with reference to a preferred embodiment, it will be understood by those skilled in the art that various changes in form and detail may be without departing from the spirit and scope of the present invention.

What is claimed is:

1. A multi-way pipe connector for a tubular frame, applied to connect a plurality of connection tubes so as to form the tubular frame, comprising:
a main connector body;
a plurality of connection protrusions, extending individually in corresponding extension directions from the main connector body, each of the connection protrusions having an outer wall including at least one annular groove; and
a plurality of elastic O-rings, each of the elastic O-rings sleeving one said corresponding annular groove of the respective connection protrusion so as to form a dimensional interference fit relationship with an inner wall of the corresponding connection tube sleeving the connection protrusion.

2. The multi-way pipe connector for a tubular frame of claim 1, wherein each of the plurality of elastic O-rings is an annular elastic O-ring.

3. The multi-way pipe connector for a tubular frame of claim 1, wherein at least one of the plurality of connection protrusions is shaped to be a column having a circular cross section.

4. The multi-way pipe connector for a tubular frame of claim 1, wherein at least two of the plurality of extension directions are perpendicular to each other.

5. The multi-way pipe connector for a tubular frame of claim 4, wherein the multi-way pipe connector is a three-way orthogonal connection assembly having the plurality of extension directions to be perpendicular to each other.

6. The multi-way pipe connector for a tubular frame of claim 4, wherein the multi-way pipe connector is a T-shape three-way connection assembly having one of the plurality of extension directions perpendicular to other two of the plurality of extension directions.

7. The multi-way pipe connector for a tubular frame of claim 4, wherein the multi-way pipe connector is a four-way connection assembly.

8. The multi-way pipe connector for a tubular frame of claim 1, wherein each of the connection protrusions is a solid column.

9. The multi-way pipe connector for a tubular frame of claim 1, wherein the main connector body is a spherical body having a diameter greater than an outer diameter of the connection protrusion.
